(19) United States
(12) Patent Application Publication
(10) Pub. No.: US 2013/0246022 A1
(43) Pub. Date: Sep. 19, 2013

(54) SCREENING POTENTIAL GEOMECHANICAL RISKS DURING WATERFLOODING

(71) Applicant: SCHLUMBERGER TECHNOLOGY CORPORATION, Sugar Land, TX (US)

(72) Inventors: Marcelo Frydman, Rio De Janeiro (BR); Jorge Aurelio Santa Cruz Pastor, Rio De Janeiro (BR); Antonio Luiz Serra de Souza, Rio De Janeiro (BR)

(73) Assignee: Schlumberger Technology Corporation, Sugar Land, TX (US)

(21) Appl. No.: 13/798,328

(22) Filed: Mar. 13, 2013

Related U.S. Application Data
(60) Provisional application No. 61/610,946, filed on Mar. 14, 2012.
(60) Provisional application No. 61/637,635, filed on Apr. 24, 2012.

(51) Int. Cl. G06F 17/50

(52) U.S. Cl. CPC G06F 17/5009
USPC 703/2; 703/10

(57) ABSTRACT

A method for a waterflooding operation in a subterranean formation includes determining a first maximum injection pressure based on an analytical model to avoid out-of-zone fracture propagation. A second maximum injection pressure is determined based on the analytical model to avoid fracture reactivation. The waterflooding operation is performed based at least on the first maximum injection pressure and the second maximum injection pressure.

### CROSS REFERENCE TO RELATED APPLICATIONS

This application claims benefit under 35 U.S.C. §119(e) to U.S. Provisional Patent Application Ser. No. 61/610,946, filed on Mar. 14, 2012, and entitled, “Screening Potential Geomechanical Risks During Waterflooding.” U.S. Provisional Patent Application Ser. No. 61/610,946 is incorporated herein by reference in its entirety. This application also claims benefit under 35 U.S.C. §119(e) to U.S. Provisional Patent Application Ser. No. 61/637,635, filed on Apr. 24, 2012, and entitled, “Screening Potential Geomechanical Risks During Waterflooding.” U.S. Provisional Patent Application Ser. No. 61/637,635 is incorporated herein by reference in its entirety.

### BACKGROUND

Geomechanics has become a tool for engineers and geologists, and plays an pronounced role in various aspects of hydrocarbon exploitation. During waterflooding, water is injected into the reservoir formation to displace residual oil. In light of the economic benefits of water injection, operators try to maximize the injection pressure and, consequently, oil recovery. However, a number of geomechanical related issues can arise. Although the subterranean assets are not limited to hydrocarbons such as oil, throughout this document, the terms “oilfield” and “oilfield operation” may be used interchangeably with the terms “field” and “field operation” to refer to a site where any types of valuable fluids can be found and the activities required for extracting them. The terms may also refer to sites where substances are deposited or stored by injecting them into the surface using boreholes and the operations associated with this process. Further, the term “field operation” refers to a field operation associated with a field, including activities related to field planning, wellbore drilling, wellbore completion, and/or production using the wellbore.

### SUMMARY

In general, in one aspect, embodiments relate to a method, system, and computer readable medium for waterflooding operation in a subterranean formation. A first maximum injection pressure is determined based on an analytical model to avoid out-of-zone fracture propagation. A second maximum injection pressure is determined based on the analytical model to avoid fracture reactivation. The waterflooding operation is performed based at least on the first maximum injection pressure and the second maximum injection pressure.

Other aspects will be apparent from the following description and the appended claims.

### BRIEF DESCRIPTION OF DRAWINGS

The appended drawings illustrate several embodiments of screening tool for geomechanical risks during waterflooding and are not to be considered limiting of its scope, for screening tool for geomechanical risks during waterflooding may admit to other equally effective embodiments.

FIG. 1.1 is a schematic view, partially in cross-section, of a field in which one or more embodiments of screening tool for geomechanical risks during waterflooding may be implemented.

FIGS. 1.2-1.11 show diagrams for modeling geomechanical risks during waterflooding in accordance with one or more embodiments.

FIG. 2 shows a screening system for geomechanical risks during waterflooding in accordance with one or more embodiments.

FIG. 3 depicts a flowchart of a method for screening geomechanical risks during waterflooding in accordance with one or more embodiments.

FIGS. 4.1-4.3 depict an example of screening tool for geomechanical risks during waterflooding in accordance with one or more embodiments.

FIG. 5 depicts a computer system using which one or more embodiments of screening tool for geomechanical risks during waterflooding may be implemented.

### DETAILED DESCRIPTION

Aspects of the present disclosure are shown in the above-identified drawings and described below. In the description, like or identical reference numerals are used to identify common or similar elements. The drawings are not necessarily to scale and certain features may be shown exaggerated in scale or in schematic in the interest of clarity and conciseness.

Aspects of the present disclosure include a method, system, and computer readable medium of screening tool for geomechanical risks during waterflooding. As noted above, operators try to maximize the injection pressure and, consequently, oil recovery during waterflooding operation. However, a number of geomechanical related issues can arise. Analytical methods for early screening of the potential geomechanical risks are described herein. The potential problems associated with waterflood techniques include fault reactivation and out-of-zone hydraulic fracture propagation. Generally, these risks may lead to the following undesired outcomes:

Fracture the cap rock;

Does not maximize oil recovery;

Does not displace residual oil;

No reservoir pressure maintenance;

Overcharge other permeable formations;

Associated drilling risks;

Contamination/Environment risks; and/or

Reduce reservoir model predictability.

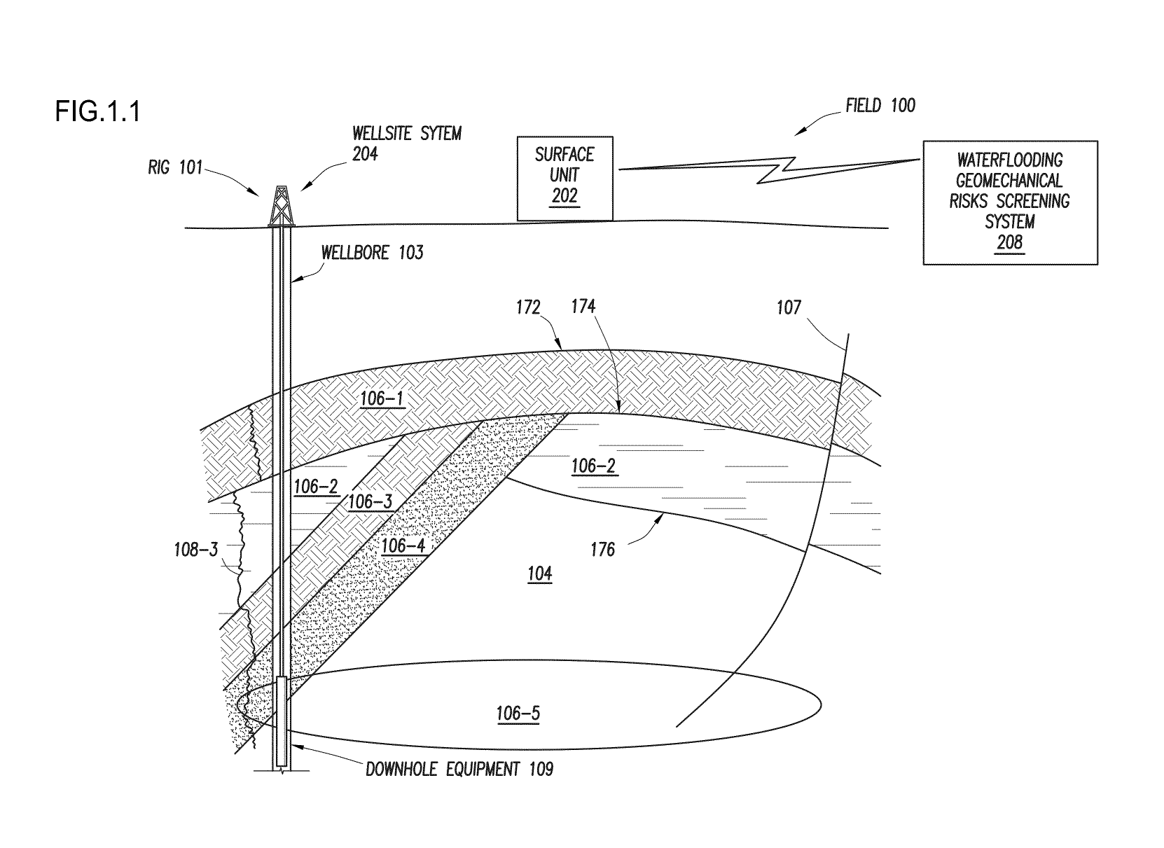

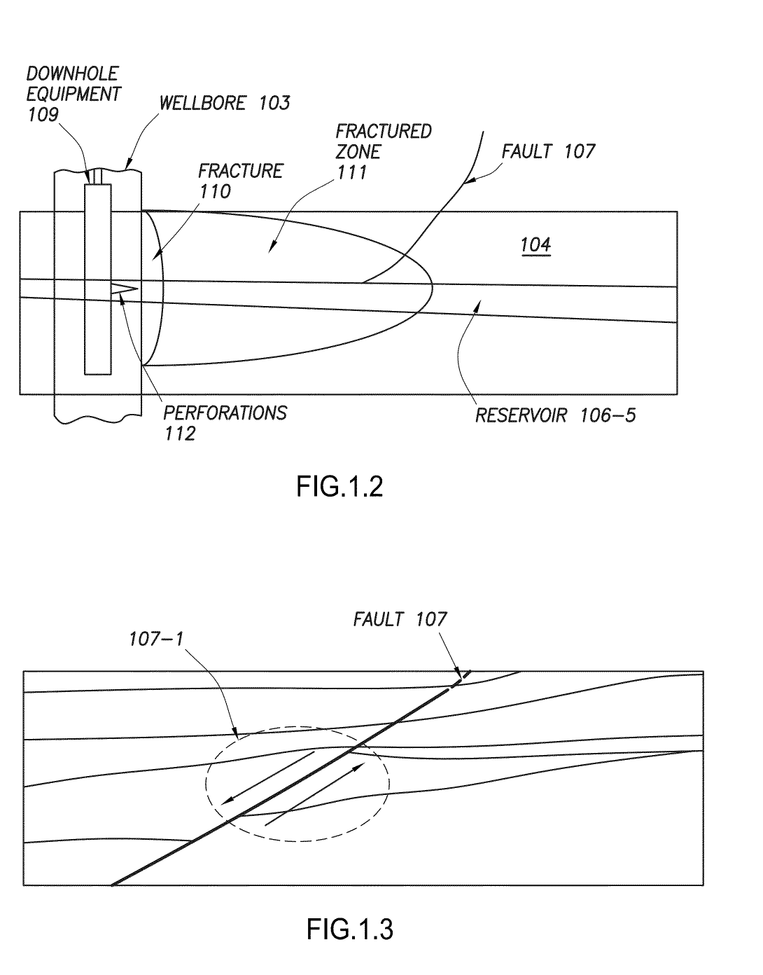

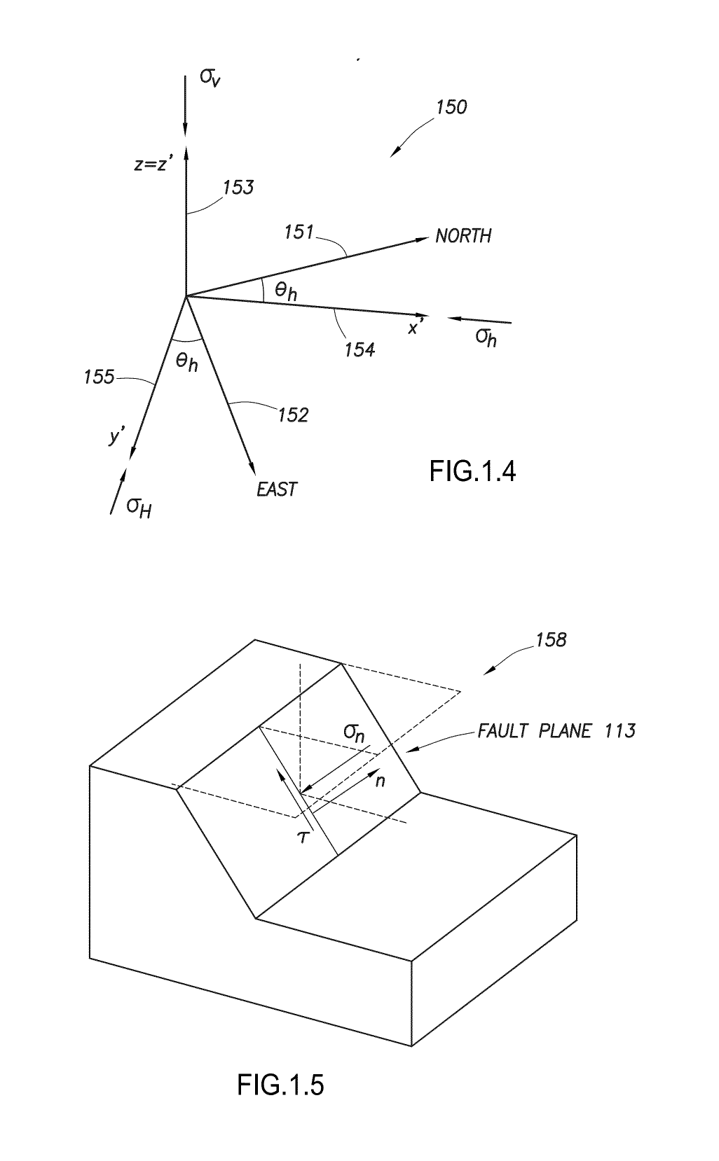

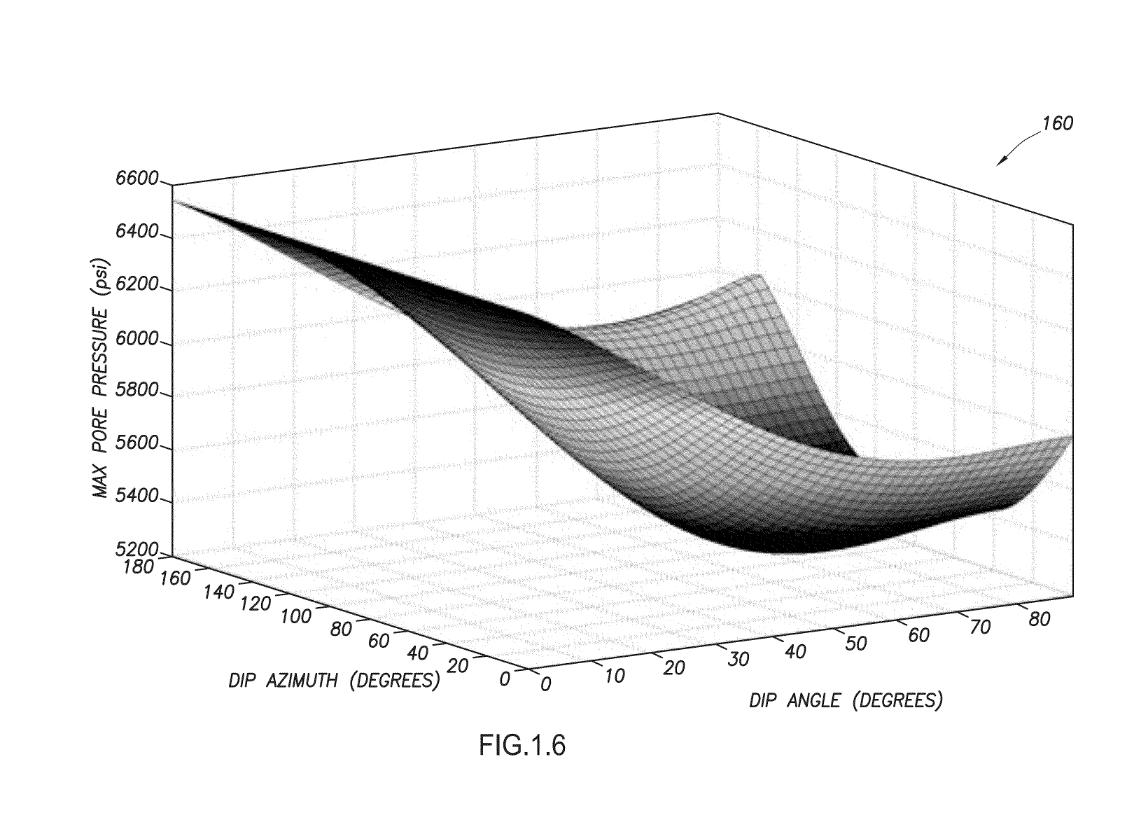

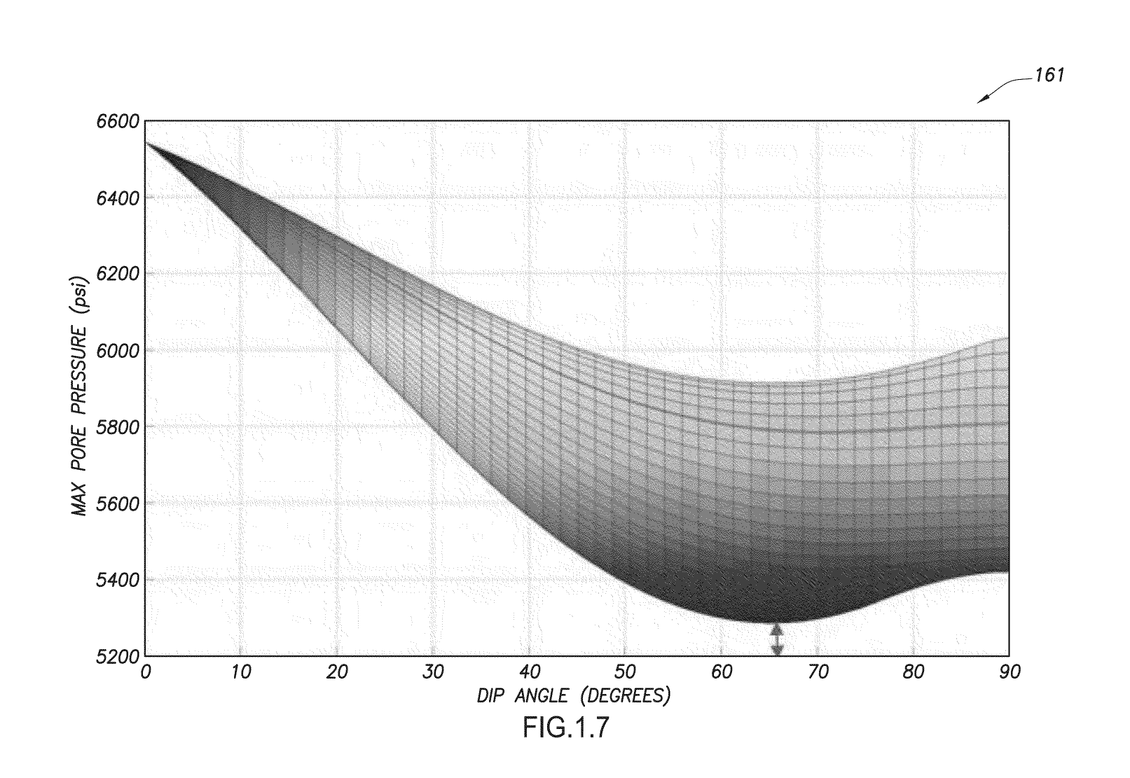

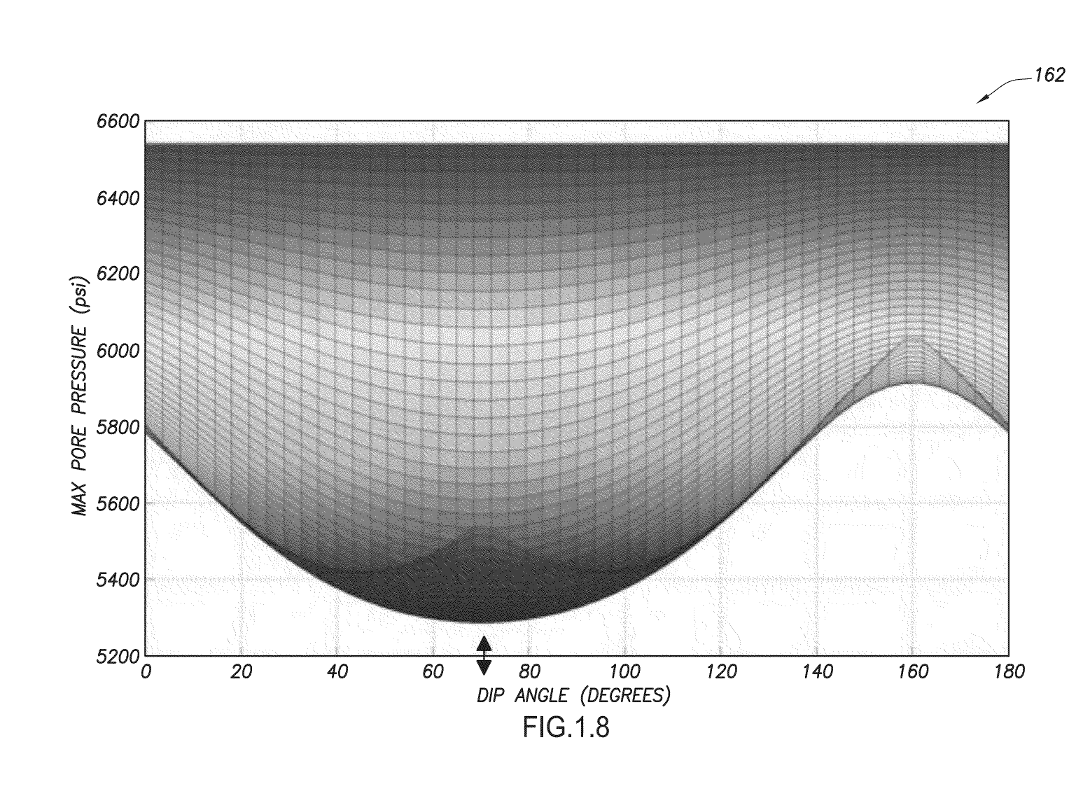

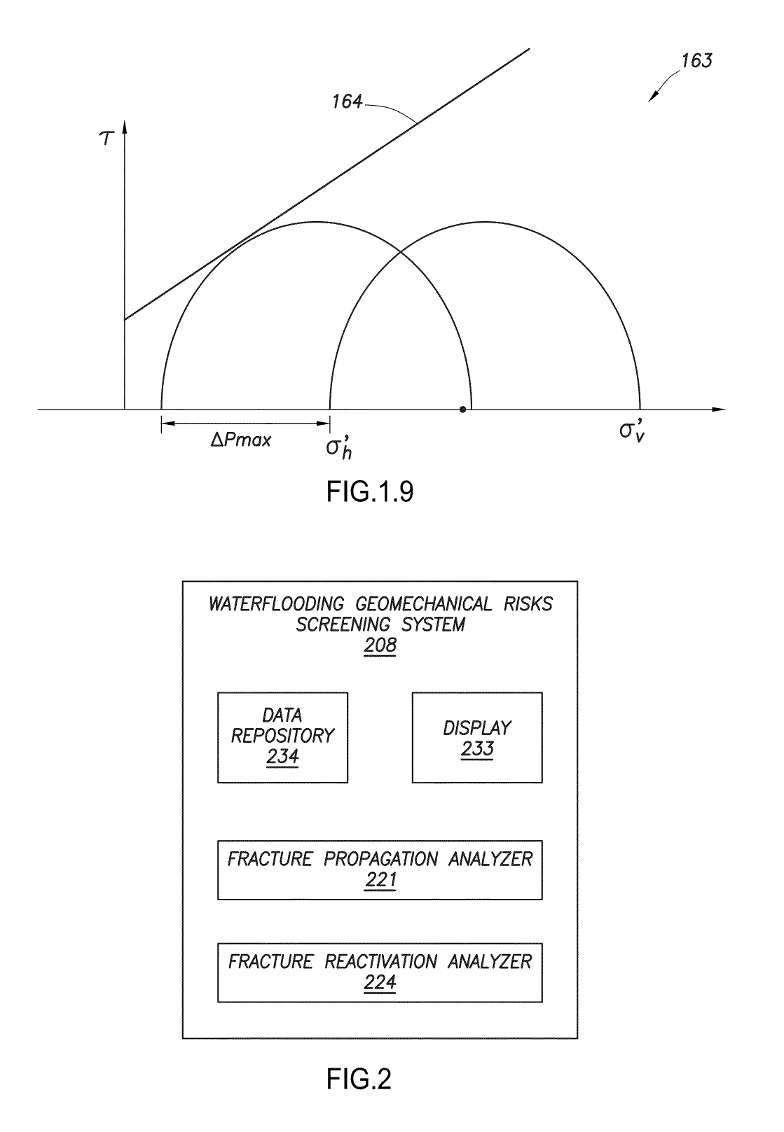

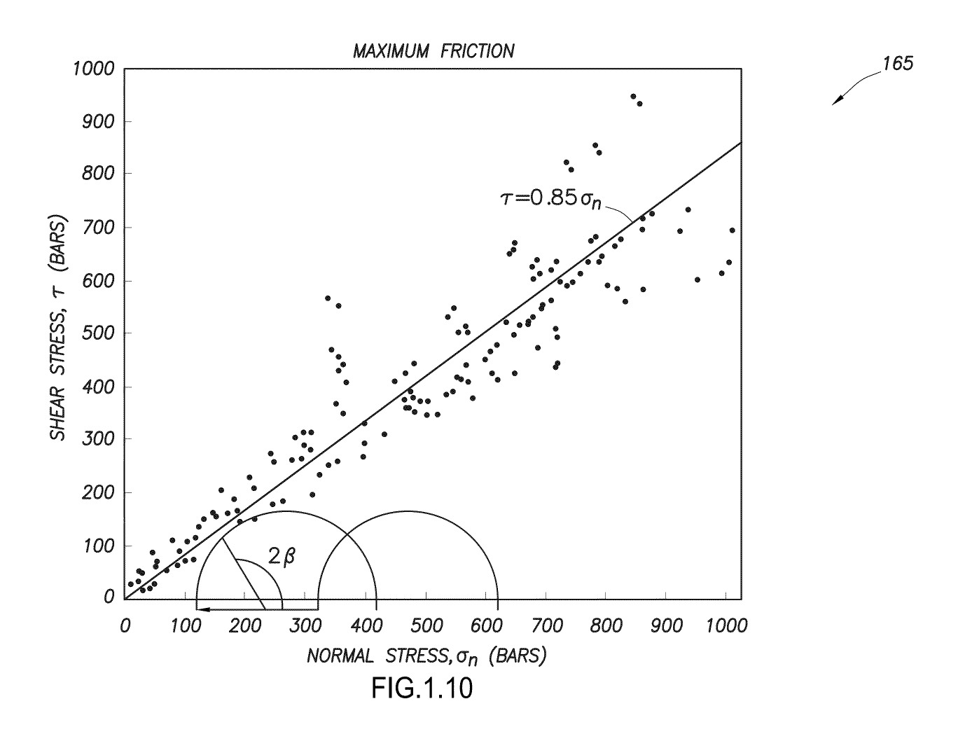

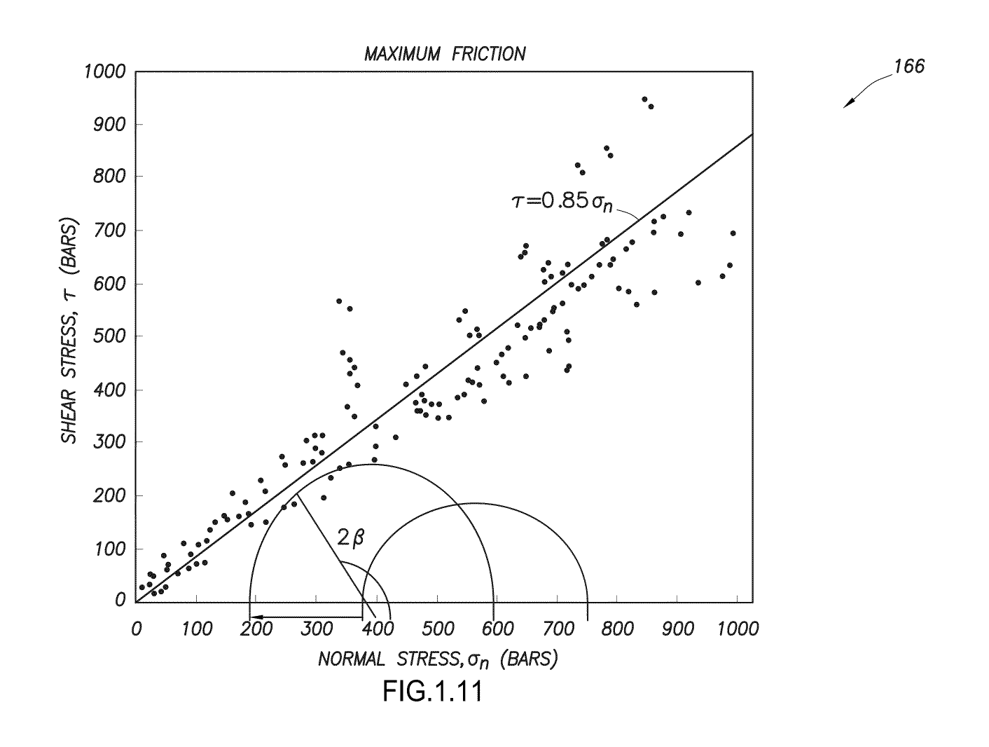

FIG. 1.1 depicts a schematic view, partially in cross section, of a field (100) in which one or more embodiments of screening tool for geomechanical risks during waterflooding may be implemented. In one or more embodiments, one or more of the modules and elements shown in FIG. 1.1 may be omitted, repeated, and/or substituted. Accordingly, embodiments of screening tool for geomechanical risks during waterflooding should not be considered limited to the specific arrangements of modules shown in FIG. 1.1.

As shown in FIG. 1.1, the subterranean formation (104) includes several geological structures. As shown, the formation has a sandstone layer (106-1), a limestone layer (106-2), a shale layer (106-3), a sand layer (106-4), a plurality of horizons (172, 174, 176), and a reservoir (106-5). A fault line (107) extends through the formation intersecting these geological structures. In one or more embodiments, various survey tools and/or data acquisition tools are adapted to measure the formation and detect the characteristics of the geological structures of the formation.

As shown in FIG. 1.1, the wellsite system (204) is associated with a rig (101), a wellbore (103), and other wellsite equipment and is configured to perform wellbore operations, such as logging, drilling, fracturing, production, waterflooding, or other applicable operations. Generally, these operations are also referred to as field operations of the field (100). These field operations are often performed as directed by the surface unit (202).

In one or more embodiments, the surface unit (202) is operatively coupled to the wellsite system (204). In one or more embodiments, surface unit (202) may be located at the wellsite system (204) and/or remote locations. The surface unit (202) may be provided with computer facilities for receiving, storing, processing, and/or analyzing data from data acquisition tools (not shown) disposed in the wellbore (103) or other part of the field (104). The surface unit (202) may also be provided with or functionally for actuating mechanisms at the field (100) such as the downhole equipment (109). In one or more embodiments, the maximum pressure may be controlled by the drilling fluid density and surface pressure in an application while drilling where the pump is used to drill. The surface unit (202) may then send command signals to the field (100) in response to data received, for example to control and/or optimize various field operations described above, in particular the waterflooding operation.

As noted above, the surface unit (202) is configured to communicate with data acquisition tools (not shown) disposed throughout the field (104) and to receive data therefrom. In one or more embodiments, the data received by the surface unit (202) represents characteristics of the subterranean formation (104) and may include information related to porosity, saturation, permeability, natural fractures, stress magnitude and orientations, elastic properties, etc. during a drilling, fracturing, logging, or production operation of the wellbore (103) at the wellsite system (204). For example, data plot (108-3) may be a wireline log, which is a measurement of a formation property as a function of depth taken by an electrically powered instrument to infer properties and make decisions about drilling and production operations.

In one or more embodiments, the surface unit (202) is operatively coupled to the downhole equipment (109) to send commands to the downhole equipment (109) and to receive data therefrom. For example, the downhole equipment (109) may be adapted for injecting water (or other types of fluids) at a controlled temperature and pressure through one or more perforations in the wellbore (103). An expanded view of the subterranean formation (104) and the downhole equipment (109) is depicted in FIG. 1.2 illustrating the aforementioned out-of-zone hydraulic fracture propagation. As shown in FIG. 1.2, the downhole equipment (109) injects water (or other types of fluids) through the perforations (112) into the formation (104) to initiate and propagate the fracture (110). As a result, the injected water flows through the perforations (112), the fracture (110), and the fractured zone (111) to form a waterflooding zone inside the reservoir (106-5). In one or more embodiments, the fracture (110) is to be confined within the reservoir (106-5) by caprock in the formation (104) serving as barrier to the waterflooding. The caprock barrier is represented by the dash line boundary of the reservoir (106-5). In the example shown in FIG. 1.2, the pressure at which the downhole equipment (109) injects the water exceeds a maximum threshold so as to cause the fracture (110) and the fractured zone (111) to propagate beyond the confinement of the caprock. Such scenario is referred to as the out-of-zone hydraulic fracture propagation.

Further, an expanded view of the formation (104) near the fault (107) and near the waterflooding zone (111) is depicted in FIG. 1.3 illustrating the aforementioned fault reactivation. As shown in FIG. 1.3, the pressure at which the downhole equipment (109) of FIG. 1.1 injects the water exceeds a maximum threshold so as to cause the fault (107) to be re-activated (i.e., slipping) as indicated by the arrows (107-1).

Returning to the discussion of FIG. 1.1, in one or more embodiments, the surface unit (202) is communicatively coupled to a waterflooding geomechanical risks screening system (208). In one or more embodiments, the data received by the surface unit (202) may be sent to the waterflooding geomechanical risks screening system (208) for further analysis. Generally, the waterflooding geomechanical risks screening system (208) is configured to determine a maximum waterflooding injection pressure based on the data provided from the surface unit (202), such as wireline logs, logging while drilling, seismic, cores, drilling data, etc.

Due to the complexity of the problems and coupled interactions between production, injection and stress change, a comprehensive analysis of the waterflooding geomechanical risks traditionally uses numerical modeling involving coupling of geomechanics with porous media fluid flow, injection and fault behavior. However, the analytical equations are very useful and present many advantages when compared to numerical models. Analytical methods for early screening the potential geomechanical risks are used by the waterflooding geomechanical risks screening system (208) to model the out-of-zone hydraulic fracture propagation and fault reactivation and to determine the maximum injection pressure before these geomechanical risks take place.

FIGS. 1.2-1.11 show diagrams for modeling geomechanical risks during waterflooding in accordance with one or more embodiments.

The analytical equations for modeling out-of-zone fracture propagation are discussed below in reference to FIG. 1.2. Fracture cannot propagate across the caprock (represented by the dash line boundary of the reservoir (106-5)) if the injection pressure is less than the minimum principal stress in caprock serving as the impermeable barrier. Thus, minimum horizontal stress is the pressure limit to avoid propagating the fracture across the barrier.

In one or more embodiments, some simplifications are used to derive the analytical equations: minimum horizontal stress is considered as the minimum principal stress; the fracture energy for propagation is not considered; and friction loss during injection is neglected (pressure loss during water flow inside the fracture). Consequently, the developed formulation is designed to be a conservative solution, convenient to screen initial risk. In one or more embodiments, the temperature difference between injection fluid and formation is included.

The maximum injection pressure to avoid fracture propagation across the barrier is given by:

$$Δ {P}_{max} = {σ}_{h} + \frac{E {α}_{T}}{1 - v} Δ T - {P}_{V} \qquad ( 1 )$$

Where ΔPₘₐₓ is the injection pressure increment with respect to the reservoir pressure (Pp), σₕ is the minimum horizontal stress at the barrier and ΔT is the temperature difference between injected fluid and formation barrier. The elastic properties at the impermeable barrier are the Young's Modulus (E), fluid thermal expansion coefficient (α_{T}) and Poisson's Ratio (ν).

The analytical equations for modeling fault reactivation are discussed below in reference to FIGS. 1.4-1.11. Fault reactivation modeled in these analytical equations is the fault slip produced when the injected fluid locally increases the pore pressure into the fault. The slip tendency analysis based on frictional constraints is used to assess the likelihood of waterflooding induced fault reactivation that may enhance leakage pathways. Fault reactivation may cause undesired connection between different reservoirs, or connection between the reservoir and the surface causing oil and gas seeps.

The normal and shear stresses applied in the fault depends on the orientation of the fault, related to the in situ stresses. Therefore, the analysis on fault reactivation will start from general context, which is any fault orientation with respect to the far field stress. After that, the critical fault orientation, where the injection pressure without slip tendency is reduced, will be identified.

In order to develop a general scheme that can take into consideration any orientations of in situ stresses and fault orientation, it is convenient to introduce a particular system of coordinate system (150) shown in the FIG. 1.4, where N-axis (151) directing to the North, E-axis (152) to the East and Z-axis (153) directing vertically downwards. The direction of the vertical stress coincides with the Z-axis (154) and the two horizontal stresses (154, 155) are in the N-E plane. The stress coordinate system (150) corresponds to the in situ stress directions, where the vertical stress (σᵥ) points along Z direction, the minimum horizontal stress (σₕ) (154) points along x′ direction, and the maximum horizontal stress points (155) along y′ direction. θₕ is the azimuth of the minimum horizontal stress (σₕ). This coordinate system is referred to as the NEZ system.

Deriving the analytical equations for modeling the fault reactivation is to rotate the in situ stresses (σ_{h,σ}ᵥ,σ_{H}) to the general system (NEZ) is presented starting in the FIG. 1.4. The rotational matrix A is defined as:

$$A = ( \begin{matrix}cos ( {θ}_{h} ) & sin ( {θ}_{h} ) & 0 \\ - sin ( {θ}_{h} ) & cos ( {θ}_{h} ) & 0 \\ 0 & 0 & 1\end{matrix} ) \qquad ( 2 )$$

E is the in situ stress tensor on the stress coordinate system (150) (σₕ,σᵥ,σ_{H}), and is given by:

$$E = ( \begin{matrix}{σ}_{h} & 0 & 0 \\ 0 & {σ}_{H} & 0 \\ 0 & 0 & {σ}_{u}\end{matrix} ) \qquad ( 3 )$$

S corresponds to the stress tensor in the general coordinate system, and is given by:

$$S = ( \begin{matrix}{σ}_{x} & {τ}_{xy} & {τ}_{xz} \\ {τ}_{xy} & {σ}_{y} & {τ}_{yz} \\ {τ}_{xz} & {τ}_{yz} & {σ}_{z}\end{matrix} ) = {A}^{T} . E . A \qquad ( 4 )$$

The stresses with respect to the fault plan are then calculated. FIG. 1.5 presents a three dimensional (3D) schematic diagram (158) of the normal and shear stress around the fault (107), represented by the fault plane (113) in a 3D view. Generally, the fault orientation is described using the parameter fault Dip (δ) and Dip Azimuth (α_{d}). Accordingly, the normal vector n perpendicular to the fault plane (107) is given by:

n=[sin(δ)cos(α_{d})sin(δ)sin(α_{d})−cos(δ)] (6)

The normal stress (σₙ) on the fault would be a scalar given by:

σₙ=n·S·N^{T} (7)

The total stress (σₜ) over the fault would be given by a vector with coordinates NEZ. This vector is obtained by:

αᵥ=n·S (8)

Finally the shear stress (τ) over the fault can be obtained by:

$$τ = \sqrt{{‖ \text{?} ‖}^{\text{?}} - \text{?}} \\ \text{?} \text{indicates text missing or illegible when filed} \qquad ( 9 )$$

The obtained stresses will be verified against the Mohr-Coulomb criterion along the fault plane (113) as:

$$\begin{matrix}τ \leq {C}_{o} + ( {σ}_{n} - α {P}_{p} ) tan ( ϕ ) & ( 10 ) \\ {P}_{p} \leq {σ}_{n} - \frac{( τ - {C}_{o} )}{tan ( ϕ )} & ( 11 )\end{matrix}$$

Where Cₒ is the fault cohesion and c is the fault friction angle. Equation 11 determines the maximum injection pressure (Pₚ) for a general fault orientation to avoid shear failure and resultant slippage, i.e., the fault reactivation. Next, the critical fault orientation is calculated. FIG. 1.6 shows a plot (160) depicting the maximum pore pressure (i.e., Pₚ in equation 11) in an example fault that can lead to shear failure. The maximum pore pressure (shown along the vertical axis) is calculated based on equation 11 as a function of fault Dip (also referred to as Dip angle) and Dip Azimuth (also referred to as Dip Azimuth angle). The example values of the fault properties and in situ stresses for this example fault are listed in TABLE 1 below.

TABLE 1
Fault Properties

| | |
|---|---|
| Cohesion (Cₒ) | 0 |
| Friction angle (φ) | 40.36° |
| Fault dip (β) | 65.18° |
| Azimuth of σₕ (θₕ) | 70° |

In Situ Stresses

| | |
|---|---|
| Vertical stress (σ_{V}) | 6523.4 psi |
| Minimum Horizontal stress (σh) | 5554.6 psi |
| Maximum Horizontal stress (σ_{H}) | 6350.2 psi |

FIG. 1.7 shows the same plot in X-Z view (161), i.e., the maximum injection pressure as a function of Dip angle. The critical fault plane dip can be identified when the injection pressure is minimum. Following the Mohr-Columb criterion, the critical dip angle is given by:

$$β = ( \frac{π}{4} + \frac{ϕ}{2} ) \qquad ( 12 )$$

Based on FIG. 1.7, β is 6 [symbol] .18° for the example above.

FIG. 1.8 shows a plot (162) of the maximum injection pressure as function of Dip Azimuth angle. It can be observed that the critical Dip Azimuth angle is the Azimuth σₕ (θₕ). To configure the screening function for the most critical fault orientation, the model is based on the following assumptions:

(i) The fault is oriented in the critical direction, where Dip angle equals to the Beta angle (Equation 12), and Dip Azimuth equals to the Azimuth of σₕ.

(ii) The pore pressure in the cap rock varies only into the fault, but constant in the impermeable formation.

(iii) The total stresses in the cap rock vary due to thermal effects.

According to the Mohr-Columb criterion, the β critical stress relationship generating shear failure along the fault can be written as:

σ′ᵥ≦UCS+σ′ₕ tan² β (13)

where:
σ′ᵥ Vertical effective stress, or overburden effective stress;
UCS Unconfined compressive strength of the fault, which may be assumed as 0;
σ′ₕ Effective minimum horizontal stress;
β Critical fault dip where φ is the friction

$$angle = ( \frac{π}{4} + \frac{ϕ}{2} ) .$$

Considering that water injection increases the fault pore pressure and consequently reduces the fault effective stresses, the critical variation on pore pressure (ΔP) that induces shear failure can be expressed as:

σ′ᵥ+Δσ′ᵥ≦UCS+(σ′ₕ+Δσ′ₕ)tan² β (14)

where

Δσ′ᵥ Variation in effective vertical stress

Δσ′ₕ Variation in effective minimum horizontal stress

Considering the assumption (iii), the stress variation as a function of the temperature difference between the injected fluid and cap rock formation can be obtained:

$$\begin{matrix}{Δσ}_{v}^{′} = \frac{E {α}_{T}}{1 - v} Δ T - α Δ P & ( 15 ) \\ Δ {σ}_{h}^{′} - \frac{E {α}_{T}}{1 - v} Δ T - α Δ P & ( 16 )\end{matrix}$$

where

ν Poisson's ratio (barrier)

α Biot's poroelastic coefficient (barrier)

α_{T} Fluid thermal expansion coefficient

Substituting Eqs. (15) and (16) into (14) produces

$$( {σ}_{v}^{′} + \frac{E {α}_{T}}{1 - v} Δ T - αΔ P ) = UCS + ( {σ}_{h}^{′} + \frac{E {α}_{T}}{1 - v} Δ T - α Δ P ) {tan}^{2} β \qquad ( 17 )$$

Substituting the Biot's effective stress and rearranging the equation (17), the maximum injection pressure for the critical fault orientation is given by:

$$Δ P \leq \frac{UCS - {σ}_{v} + {σ}_{h} {tan}^{2} β}{α ( {tan}^{2} β - 1 )} + \frac{E {α}_{T}}{α ( 1 - v )} Δ T - {P}_{p} \qquad ( 18 )$$

The relationship between the minimum horizontal stress (σₕ) and the effective minimum horizontal stress (σ′ₕ) is given by the Biot's effective stress as:

σ′ₕ=σₕ−α

[symbol]

[symbol]

The pore pressure is changing along reactivated faults according to the equation (18). FIG. 1.9 shows a graph (163) representing changing pore pressure along the reactivated faults by moving the Mohr's circle to the left, with the same size, when increasing of pore pressure. Mohr's circle is a two-dimensional graphical representation of the state of stress at a point. The maximum injection pressure ΔPₘₐₓ that can be used without inducing the fault reactivation is estimated by the distance along the horizontal axis that shifts the Mohr circle until it touches the failure envelope, which is defined by equation (11) and represented by the straight line (164) in FIG. 1.9.

The example in FIG. 1.10 shows an example (165) based on Byerlee's criterion for estimating fault slipping. Byerlee's criterion establishes a critical envelope in FIG. 1.10 given by:

τ=0.85σ (19)

Equation (20) corresponds to the Mohr-Coulomb properties of:

C [symbol] =0, φ=40.36°

Replacing these values in equation (18), and assigning the Biot coefficient as 1, the maximum injection pressure ΔPₘₐₓ to avoid fault reactivation can be derived as:

$$Δ {P}_{max} \leq 1.272 {σ}_{h} - 0.272 {σ}_{v} + \frac{E {α}_{T}}{( 1 - v )} Δ T - {P}_{V} \qquad ( 20 )$$

where ΔPₘₐₓ is the maximum injection pressure increment in the fault and ΔT=T^{Fluid}−T_{Formation}. Analyzing ΔT in Equation (20) can be seen that the lower the temperature of the fluid injected the lower ΔPₘₐₓ will be allowed.

FIG. 1.10 is based on the simplification of ΔT=0. However, temperature effects need to be included since the injected water temperature is generally colder than the formation temperature. Due to temperature changes the stress path would not follow a constant-size Mohr's circle, as shown in FIG. 1.10. The temperature would affect both stresses in a different magnitude, so that the Mohr's circle will be changing in size as shown in the example (166) in FIG. 1.11. As a result, the maximum injection pressure allowed to avoid fault reactivation would be lower than in the isothermal case shown in FIG. 1.10.

FIG. 2 shows more details of the waterflooding geomechanical risks screening system (208) in which one or more embodiments of screening tool for geomechanical risks during waterflooding may be implemented. As shown in FIG. 2, the waterflooding geomechanical risks screening system (208) includes a fracture propagation analyzer (221), a fracture reactivation analyzer (224), a data repository (234), and a display (233). In one or more embodiments, one or more of the modules and elements shown in FIG. 2 may be omitted, repeated, and/or substituted. Accordingly, embodiments of screening tool for geomechanical risks during waterflooding should not be considered limited to the specific arrangements of modules shown in FIG. 2.

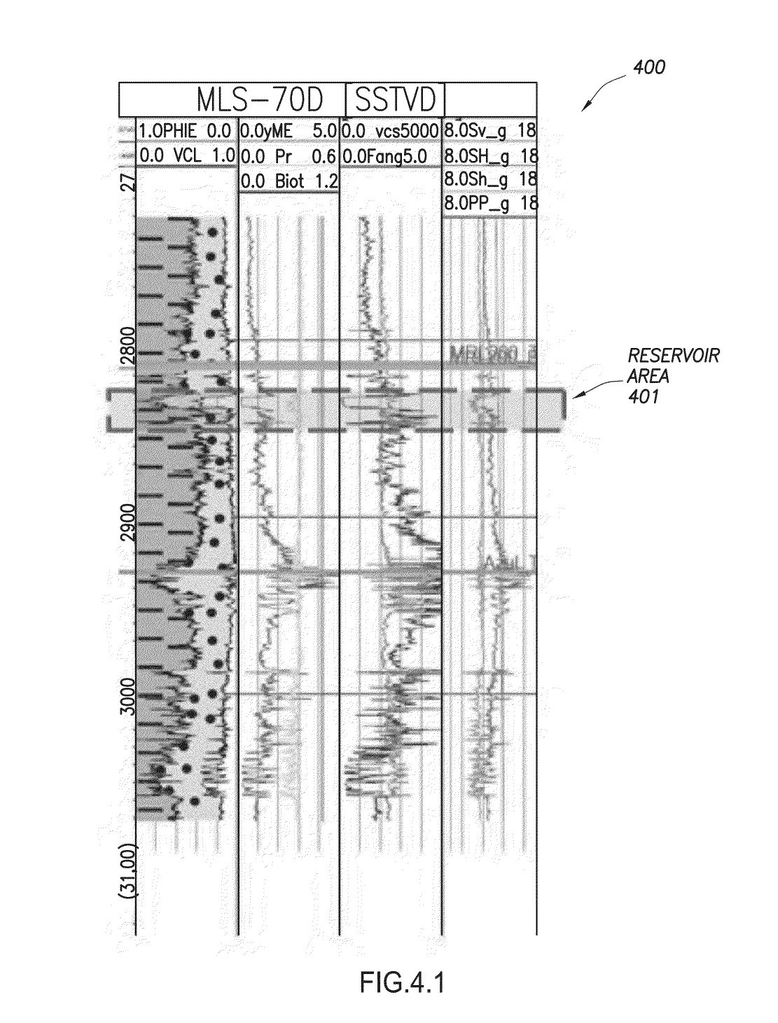

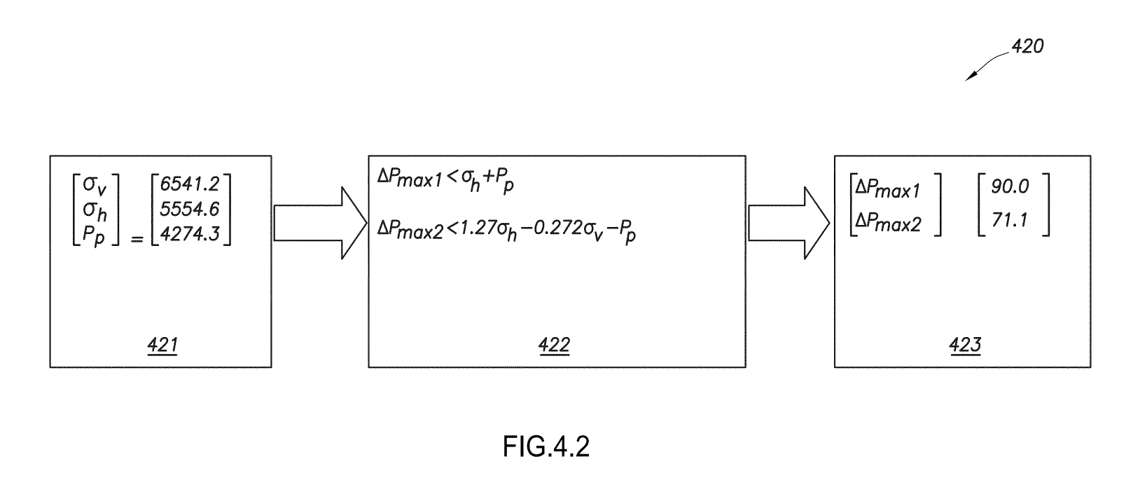

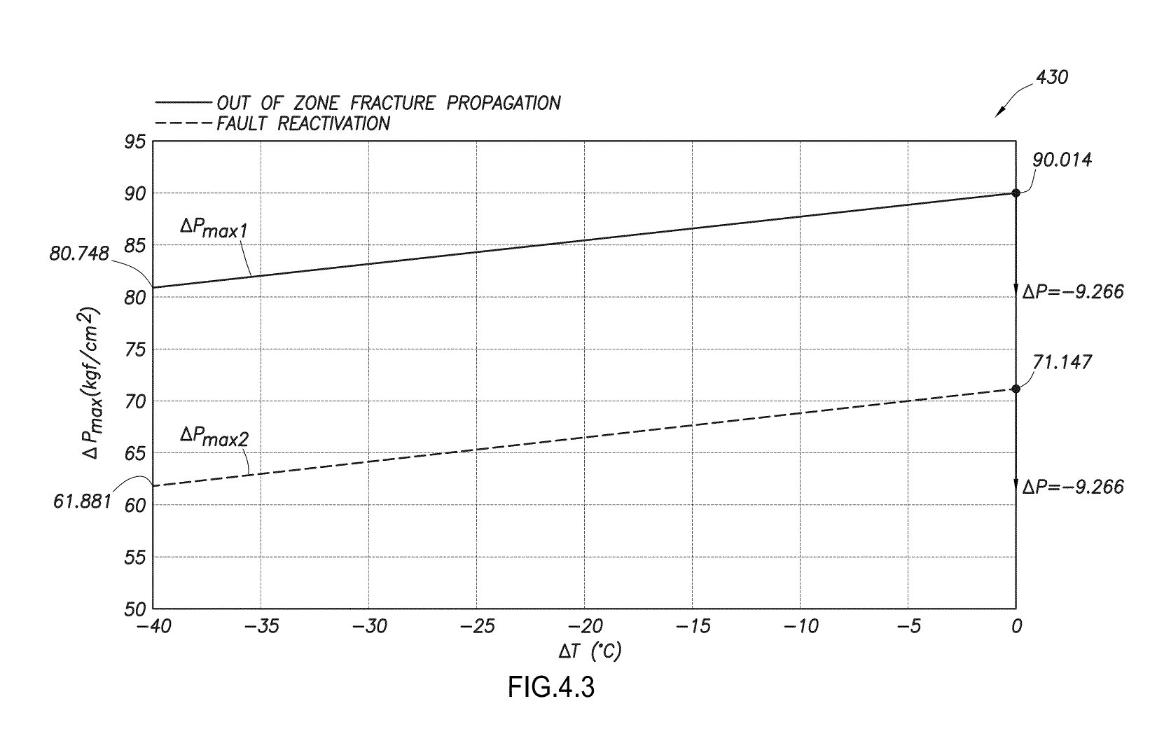

In one or more embodiments, the waterflooding geomechanical risks screening system (208) includes the fracture propagation analyzer (221) that is configured to determine a first maximum injection pressure based on an analytical model to avoid out-of-zone fracture propagation. The out-of-zone fracture propagation is described in reference to FIG. 1.2 above. In one or more embodiments, the analytical model is based on the equation 1 described in reference to FIG. 1.2 above. An example analytical model is described in reference to FIGS. 4.1-4.3 below.

In one or more embodiments, the fracture propagation analyzer (221) is a software module.

In one or more embodiments, the waterflooding geomechanical risks screening system (208) includes the fracture reactivation analyzer (224) that is configured to determine a second maximum injection pressure based on the analytical model to avoid fracture reactivation. The fracture reactivation is described in reference to FIG. 1.3 above. In one or more embodiments, the analytical model is based on the equations 2-20 described in reference to FIGS. 1.3-1.11 above. An example analytical model is described in reference to FIGS. 4.1-4.3 below.

In one or more embodiments, the fracture reactivation analyzer (224) is a software module.

In one or more embodiments, the waterflooding geomechanical risks screening system (208) includes the data repository (234) that is configured to store the analytical model and any input, output and intermediate working data used by the analytical model. In one or more embodiments, the data repository (234) may be a disk storage device, a semi-conductor memory device, or any other suitable device for data storage.

In one or more embodiments, the waterflooding geomechanical risks screening system (208) includes the display (233) that is configured to display the result of the analytical model and any input, output and intermediate working data used by the analytical model. For example, information described in reference to FIGS. 4.1-4.3 below may be displayed using the display (233). In one or more embodiments, the display (233) may be a two dimensional display device, a three dimensional display device, a flat panel display device, a CRT based display device, or any other suitable information display device.

In one or more embodiments, the surface unit (202) of FIG. 1.1 performs the waterflooding operation based at least on the first maximum injection pressure and the second maximum injection pressure as determined by the fracture propagation analyzer (221) and the fracture reactivation analyzer (224).

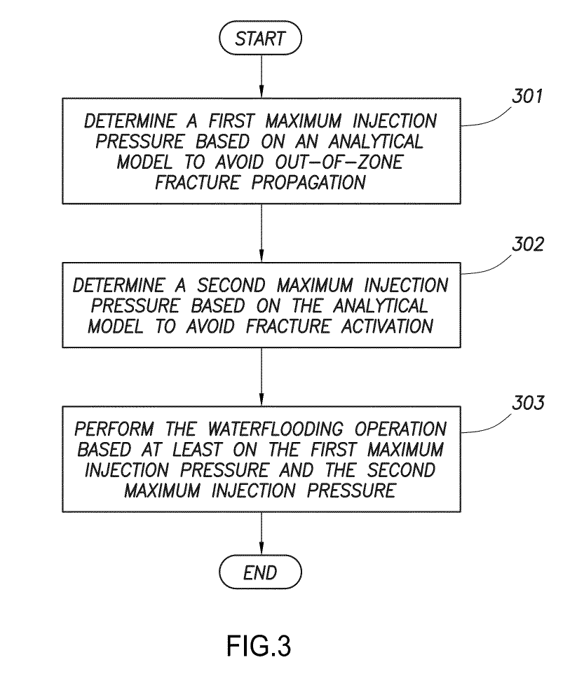

FIG. 3 depicts an example method for screening tool for geomechanical risks during waterflooding in accordance with one or more embodiments. For example, the method depicted in FIG. 3 may be practiced using the waterflooding geomechanical risks screening system (208) described in reference to FIGS. 1.1 and 2 above. In one or more embodiments, one or more of the elements shown in FIG. 3 may be omitted, repeated, and/or performed in a different order. Accordingly, embodiments of screening tool for geomechanical risks during waterflooding should not be considered limited to the specific arrangements of elements shown in FIG. 3.

Initially in block 301, a first maximum injection pressure is determined based on an analytical model to avoid out-of-zone fracture propagation. As noted above, the out-of-zone fracture propagation is described in reference to FIG. 1.2. In one or more embodiments, the analytical model is based on the equation 1 with additional details described in reference to FIGS. 4.1-4.3 below. In one or more embodiments, determining the first maximum injection pressure based on the analytical model to avoid out-of-zone fracture propagation is described in reference to FIGS. 1.3-1.11 above.

In block 302, a second maximum injection pressure is determined based on an analytical model to avoid fracture reactivation. As noted above, the fracture reactivation is described in reference to FIG. 1.3. In one or more embodiments, the analytical model is based on the equations 2-20 with additional details described in reference to FIGS. 4.1-4.3 below. In one or more embodiments, determining the second maximum injection pressure based on the analytical model to avoid fracture reactivation is described in reference to FIGS. 1.3-1.11 above.

In block 303, the waterflooding operation is performed based at least on the first maximum injection pressure and the second maximum injection pressure. In one or more embodiments, the first maximum injection pressure and the second maximum injection pressure are compared to determine the lower of the two as the maximum limit for the water injection pressure during the waterflooding operation.

FIGS. 4.1-4.3 depict an example of screening tool for geomechanical risks during waterflooding in accordance with one or more embodiments.

The mechanical earth model (MEM) is a numerical representation of the state of stress and rock mechanical properties for a specific stratigraphic section in a field or basin. FIG. 4.1 shows a one dimensional (1D) view (400) of an example MEM that captures the geomechanics/drilling knowledge gained from offset wells and includes geological and geophysical properties for each formation as well as stress relationships and mechanical properties. In particular, the MEM includes a portion that corresponds to a reservoir area (401).

The workflow (420) for the analysis to derive the maximum waterflooding pressure in the reservoir area (401) is illustrated in FIG. 4.2 where stresses are in units of kgf/cm². As shown in FIG. 4.2, workflow block (421) represents obtaining values of the stresses and pore pressure in the formation and reservoir area based on the MEM. Workflow block (422) represents modeling the waterflooding operation in the reservoir area (401) using the aforementioned analytic equations to avoid out-of-zone fault propagation and fault reactivation. Workflow block (423) represents calculating the maximum injection pressure ΔPₘₐₓ₁ to avoid out-of-zone fault propagation and the maximum injection pressure ΔPₘₐₓ₂ to avoid fault reactivation in the reservoir area (401) as the modeling results. The particular values of these maximum injection pressures shown in FIG. 4.2 are based on zero temperature effect.

FIG. 4.3 shows a chart (430) showing that the temperature affects the maximum injection pressures ΔPₘₐₓ₁ and ΔPₘₐₓ₂. This effect is more useful for fault reactivation than for out-of-zone fracture propagation. TABLE 2 presents the reduction (%) in the maximum injection pressures, according to equation (20).

TABLE 2

| ΔT (° C.) | ΔPₘₐₓ |
|---|---|
| 0 | 0 |
| −10 | 2.57% |
| −20 | 5.15% |
| −30 | 7.72% |
| −40 | 10.29% |

Characterizing the geomechanics risks based on the screening analysis is useful to plan for mitigations. Mitigations may include reducing injection pressure to acceptable risk; developing a more detailed comprehensive analysis; and monitoring fracture propagation during the waterflooding operation. Understanding the various potential processes and ability to predict the field behavior is useful for the optimal management of the reservoir for maximum productivity and recovery using the waterflooding operation.

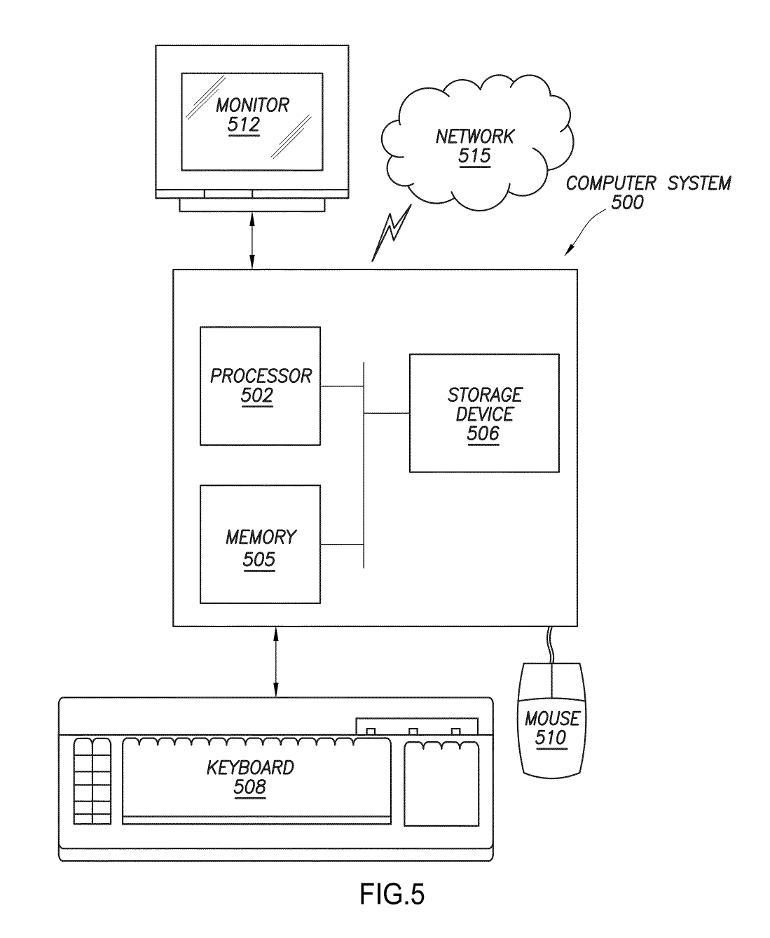

Embodiments of screening tool for geomechanical risks during waterflooding may be implemented on virtually any type of computer regardless of the platform being used. For instance, as shown in FIG. 5, a computer system (500) includes one or more computer processor(s) (502) such as a central processing unit (CPU) or other hardware processor, associated memory (505) (e.g., random access memory (RAM), cache memory, flash memory, etc.), a storage device (506) (e.g., a hard disk, an optical drive such as a compact disk drive or digital video disk (DVD) drive, a flash memory stick, etc.), and numerous other elements and functionalities of today's computers (not shown). The computer (500) may also include input means, such as a keyboard (508), a mouse (510), or a microphone (not shown). Further, the computer (500) may include output means, such as a monitor (512) (e.g., a liquid crystal display LCD, a plasma display, or cathode ray tube (CRT) monitor). The computer system (500) may be connected to a network (515) (e.g., a local area network (LAN), a wide area network (WAN) such as the Internet, or any other similar type of network) via a network interface connection (not shown). Many different types of computer systems exist (e.g., workstation, desktop computer, a laptop computer, a personal media device, a mobile device, such as a cell phone or personal digital assistant, or any other computing system capable of executing computer readable instructions), and the aforementioned input and output means may take other forms, now known or later developed. Generally speaking, the computer system (500) includes at least the minimal processing, input, and/or output means to practice one or more embodiments.

Further, one or more elements of the aforementioned computer system (500) may be located at a remote location and connected to the other elements over a network. Further, one or more embodiments may be implemented on a distributed system having a plurality of nodes, where each portion of the implementation may be located on a different node within the distributed system. In one or more embodiments, the node corresponds to a computer system. In one or more embodiments, the node may correspond to a processor with associated physical memory. In one or more embodiments, the node may correspond to a processor with shared memory and/or resources. Further, software instructions to perform one or more embodiments may be stored on a computer readable medium such as a compact disc (CD), a diskette, a tape, or any other computer readable storage device.

While screening tool for geomechanical risks during waterflooding has been described with respect to a limited number of embodiments, those skilled in the art, having benefit of this disclosure, will appreciate that other embodiments may be devised which do not depart from the scope of screening tool for geomechanical risks during waterflooding as disclosed herein. Accordingly, the scope of screening tool for geomechanical risks during waterflooding should be limited only by the attached claims.

What is claimed is:

1. A method for waterflooding operation in a subterranean formation, comprising:
determining, using a computer processor, a first maximum injection pressure based on an analytical model to avoid out-of-zone fracture propagation; and
determining a second maximum injection pressure based on the analytical model to avoid fracture reactivation; and
performing the waterflooding operation based at least on the first maximum injection pressure and the second maximum injection pressure.

2. The method of claim 1, wherein determining the first maximum injection pressure comprises:
calculating an injection pore pressure increment with respect to a reservoir pressure using a minimum horizontal stress, a temperature difference, and a plurality of elastic properties.

3. The method of claim 2, further comprising:
obtaining a first temperature of the injected fluid;
obtaining a second temperature of the formation barrier; and
calculating the temperature difference between the first temperature and the second temperature.

4. The method of claim 2, wherein the plurality of elastic properties comprises Young's modulus, a fluid thermal expansion co-efficient, and Poisson's ratio.

5. The method of claim 2, wherein calculating the injection pore pressure increment comprises using the equation:
$$Δ {P}_{max} - {σ}_{h} + \frac{E {α}_{T}}{1 - v} Δ T - {P}_{V} ,$$
wherein σₕ is the horizontal stress, ν is the Poisson's ratio, α_{T} is a fluid expansion coefficient, Pₚ is the maximum pore pressure, and E is Young's modulus, and ΔT is the temperature difference.

6. The method of claim 1, wherein determining the second maximum injection pressure comprises:
calculating a change in pressure as a function of an unconfined compressive strength, a vertical stress, a horizontal stress, a poisson ratio, a maximum pore pressure, and a critical fault dip.

7. The method of claim 6, wherein the change is pressure is calculated using the equation:
$$Δ P \leq \frac{UCS - {σ}_{v} + {σ}_{h} {tan}^{2} β}{α ( {tan}^{2} β - 1 )} + \frac{E {α}_{T}}{α ( 1 - v )} Δ T - {P}_{p}$$
wherein, ΔP is the change in pressure, UCS is the unconfined compressive strength, σ_{υ} is the vertical stress, σₕ is the horizontal stress, β is the critical fault dip, ν is Poisson's ratio, α is Biot's poroelastic coefficient, α_{T} is fluid expansion coefficient, Pₚ is the maximum pore pressure, E is Young's modulus, and ΔT is a temperature difference.

8. The method of claim 1, wherein determining the second maximum injection pressure further comprises using the equation:
ΔPₘₐₓ≦1.272 σₕ 0.272 σᵥ|_{(1-ν)}^{Eα}^{_{T}}ΔT Pₚ,
wherein, ΔPₘₐₓ is a maximum injection pressure increment, is the vertical stress, σₕ is the horizontal stress, ν is Poisson's ratio, α_{T} is fluid expansion coefficient, Pₚ is the maximum pore pressure, E is Young's modulus, and ΔT is a temperature difference.

9. A system for waterflooding operation in a subterranean formation, comprising:
a surface unit comprising a computer processor and memory;
a fracture propagation analyzer stored in the memory, executing on the computer processor, and configured to determine a first maximum injection pressure based on an analytical model to avoid out-of-zone fracture propagation; and
a fracture reactivation analyzer stored in the memory and configured to determine a second maximum injection pressure based on the analytical model to avoid fracture reactivation; and
a repository configured to store the analytical model,
wherein the surface unit performs the waterflooding operation based at least on the first maximum injection pressure and the second maximum injection pressure.

10. The system of claim 9, wherein determining the first maximum injection pressure comprises:
calculating an injection pore pressure increment with respect to a reservoir pressure using a minimum horizontal stress, a temperature difference, and a plurality of elastic properties.

11. The system of claim 10, further comprising:
obtaining a first temperature of the injected fluid;
obtaining a second temperature of the formation barrier; and
calculating the temperature difference between the first temperature and the second temperature.

12. The system of claim 10, wherein the plurality of elastic properties comprises Young's modulus, a fluid thermal expansion co-efficient, and Poisson's ratio.

13. The system of claim 10, wherein calculating the injection pore pressure increment comprises using the equation:
$$Δ {P}_{max} = {σ}_{h} + \frac{E {α}_{T}}{1 - v} Δ T - {P}_{p} ,$$
wherein σₕ is the horizontal stress, ν is the Poisson's ratio, α_{T} is a fluid expansion coefficient, Pₚ is the maximum pore pressure, and E is Young's modulus, and ΔT is the temperature difference.

14. The system of claim 9, wherein determining the second maximum injection pressure comprises:
calculating a change in pressure as a function of an unconfined compressive strength, a vertical stress, a horizontal stress, a poisson ratio, a maximum pore pressure, and a critical fault dip.

15. The system of claim 14, wherein the change is pressure is calculated using the equation:
$$Δ P \leq \frac{UCS - {σ}_{v} + {σ}_{h} {tan}^{2} β}{α ( {tan}^{2} β - 1 )} + \frac{E {α}_{T}}{α ( 1 - v )} Δ T - {P}_{p}$$
wherein, ΔP is the change in pressure, UCS is the unconfined compressive strength, σᵥ is the vertical stress, σₕ is the horizontal stress, β is the critical fault dip, ν is Poisson's ratio, α is Biot's poroelastic coefficient, α_{T} is fluid expansion coefficient, Pₚ is the maximum pore pressure, E is Young's modulus, and ΔT is a temperature difference.

16. A non-transitory computer readable medium storing instructions for waterflooding operation in a subterranean formation, the instructions when executed causing a processor to:
determine a first maximum injection pressure based on an analytical model to avoid out-of-zone fracture propagation; and
determine a second maximum injection pressure based on the analytical model to avoid fracture reactivation; and
perform the waterflooding operation based at least on the first maximum injection pressure and the second maximum injection pressure.

17. The non-transitory computer readable medium of claim 16, wherein determining the first maximum injection pressure comprises:
calculating an injection pore pressure increment with respect to a reservoir pressure using a minimum horizontal stress, a temperature difference, and a plurality of elastic properties.

18. The non-transitory computer readable medium of claim 17, further comprising:
obtaining a first temperature of the injected fluid;
obtaining a second temperature of the formation barrier; and
calculating the temperature difference between the first temperature and the second temperature.

19. The non-transitory computer readable medium of claim 17, wherein the plurality of elastic properties comprises Young's modulus, a fluid thermal expansion co-efficient, and Poisson's ratio.

20. The non-transitory computer readable medium of claim 16, wherein determining the second maximum injection pressure comprises:
calculating a change in pressure as a function of an unconfined compressive strength, a vertical stress, a horizontal stress, a poisson ratio, a maximum pore pressure, and a critical fault dip.
